(19) United States
(12) Patent Application Publication
(10) Pub. No.: US 2023/0102630 A1
(43) Pub. Date: Mar. 30, 2023

(54) ANODE ACTIVE MATERIAL LAYER, AND ALKALINE STORAGE BATTERY

(71) Applicant: TOYOTA JIDOSHA KABUSHIKI KAISHA, Toyota-shi (JP)

(72) Inventor: Hiroshi SUYAMA, Mishima-shi (JP)

(21) Appl. No.: 17/933,514

(22) Filed: Sep. 20, 2022

(30) Foreign Application Priority Data
Sep. 29, 2021 (JP) 1021-158977

(51) Int. Cl. H01M 4/62; H01M 4/48; H01M 4/38; H01M 4/36; H01M 4/24; H01M 10/24

(52) U.S. Cl. CPC H01M 4/62; H01M 4/483; H01M 4/38; H01M 4/364; H01M 4/244; H01M 10/24; H01M 2004/027

(57) ABSTRACT

A main object of the present disclosure is to provide an anode active material layer with excellent cycle property. The present disclosure achieves the object by providing an anode active material layer to be used in an alkaline storage battery, the anode active material layer comprising a Zn based active material, and an additive; and the additive includes at least one kind of Mg, Sr and La; a solubility (25° C.) of the additive with respect to a potassium hydrate aqueous solution of concentration of 6 M is 120 mg/L or less; and a ratio of the additive with respect to the Zn based active material is 1 weight % or more and 60 weight % or less.

### TECHNICAL FIELD

The present disclosure relates to an anode active material layer, and an alkaline storage battery.

### BACKGROUND

As an anode active material for an alkaline storage battery, a Zn based active material has been known. For example, Patent Literature 1 discloses an anode composition in gel form for an alkaline battery including at least a zinc alloy powder, a gelatinizing agent, and an alkaline aqueous solution. Patent Literature 1 further discloses to include magnesium hydrate powder at ratio, with respect to the zinc alloy powder, of 0.01 to 0.2 weight %. Also, Patent Literature 2 discloses an alkaline secondary electrochemical generator including a zinc anode.

### CITATION LIST

### Patent Literatures

Patent Literature 1: Japanese Patent No. 4914983
Patent Literature 2: Japanese Patent Application Laid-Open (JP-A) No. 2013-016506

### SUMMARY OF DISCLOSURE

### Technical Problem

Compared to an active material including a rare earth element (such as a hydrogen storage alloy used for a Ni-MH battery), for example, the Zn based active material is environmentally friendly, and also advantageous in cost. Meanwhile, when the Zn based active material is used, the cycle property tends to be low. The present disclosure has been made in view of the above circumstances and a main object thereof is to provide an anode active material layer with excellent cycle property.

### Solution to Problem

The present disclosure provides an anode active material layer to be used in an alkaline storage battery, the anode active material layer comprising a Zn based active material, and an additive; and the additive includes at least one kind of Mg, Sr and La; a solubility (25° C.) of the additive with respect to a potassium hydrate aqueous solution of concentration of 6 M is 120 mg/L or less; and a ratio of the additive with respect to the Zn based active material is 1 weight % or more and 60 weight % or less.

According to the present disclosure, since the anode active material layer includes a predetermined additive at a predetermined ratio, the cycle property may be improved.

In the disclosure, the additive may be a hydroxide, an oxide, a fluoride, a phosphate, a pyrophosphate, or a titanate.

In the disclosure, the additive may be a hydroxide including Mg.

In the disclosure, the additive may be an oxide, a fluoride, a phosphate, a pyrophosphate, or a titanate including Mg.

In the disclosure, the additive may be a fluoride including at least one kind of Sr and La.

In the disclosure, the ratio of the additive with respect to the Zn based active material may be more than 35 weight % and 60 weight % or less.

In the disclosure, as the Zn based active material, the anode active material layer may include at least one kind of a Zn simple substance, a Zn alloy, a Zn oxide, and a Zn hydroxide.

The present disclosure also provides an alkaline storage battery comprising a cathode active material layer, an anode active material layer, and an electrolyte layer placed between the cathode active material layer and the anode active material layer, and the anode active material layer is the anode active material layer described above.

According to the present disclosure, by using the anode active material layer described above, the cycle property of the alkaline storage battery is improved.

### Advantageous Effects of Disclosure

The anode active material layer in the present disclosure exhibits an effect of excellent cycle property.

### BRIEF DESCRIPTION OF DRAWINGS

FIG. 1 is a schematic cross-sectional view exemplifying the alkaline storage battery in the present disclosure.

FIG. 2 is the result of a cycle stability evaluation to the evaluation batteries obtained in Examples 1 to 5 and Comparative Example 1.

FIG. 3 is the result of a cycle stability evaluation to the evaluation batteries obtained in Examples 6 to 10 and Comparative Example 1.

FIG. 4 is the result of a cycle stability evaluation to the evaluation batteries obtained in Examples 10 to 12 and Comparative Examples 1 to 3.

### DESCRIPTION OF EMBODIMENTS

The anode active material layer, and the alkaline storage battery will be hereinafter described in details.

A. Anode Active Material Layer

The anode active material layer in the present disclosure is used in an alkaline storage battery, and comprises a Zn based active material, and an additive. The additive includes at least one kind of Mg, Sr, and La. Also, the solubility (25° C.) of the additive with respect to a potassium hydrate aqueous solution of concentration of 6 M is 120 mg/L or less. Also, the ratio of the additive with respect to the Zn based active material is usually 1 weight % or more and 60 weight % or less.

According to the present disclosure, since a predetermined additive is included at a predetermined ratio, the anode active material layer has an excellent cycle property. As described above, compared to an active material including a rare earth element (such as a hydrogen storage alloy used for a Ni-MH battery), for example, a Zn based active material is environmentally friendly, and also advantageous in cost. Meanwhile, when the Zn based active material is used, the cycle property tends to be low. As one reason for the low cycle property, a phenomenon called a shape change of ZnO has been known.

The shape change of ZnO is a phenomenon wherein the availability of an active material is decreased due to the localization of the dissolution/deposition site of ZnO. The shape change of ZnO will be explained referring to the chemical reaction formulas. As described in the following formula (1), electrodeposition/elution reaction of metallic zinc occurs at an anode during charge/discharge.

Zn+2OH⁻↔ZnO+H₂O+2e⁻ formula (1)

Precisely, the formula (1) is constituted from the following formula (2) and formula (3). The formula (2) and formula (3) represent the reaction mechanism wherein the concentration of Zn(OH)₄²⁻ dissolved in the liquid electrolyte is maintained by the dissolution/deposition reaction of ZnO.

Zn+4OH⁻↔Zn(OH)₄²⁻+2e⁻ formula (2)

Zn(OH)₄²⁻↔ZnO+H₂O+2OH⁻ formula (3)

The solubility of Zn(OH)₄²⁻ is responsive to the environment of the liquid electrolyte (such as concentration of the solute and temperature of the liquid electrolyte). The environment of the liquid electrolyte becomes uneven in the battery during charge/discharge reaction. Attendant thereto, the concentration of Zn(OH)₄²⁻ in the liquid electrolyte also becomes uneven. Therefore, the deposition of ZnO preferentially occurs at site with high Zn(OH)₄²⁻ concentration, and as the result, a shape change of ZnO (a change in shape when ZnO is generated from Zn) occurs.

In contrast to this, in the present disclosure, the cycle property is improved by including at least one kind of Mg, Sr and La, and using an additive having poor solubility with respect to the liquid electrolyte (alkaline solution). The reason therefor is presumed that since the additive having poor solubility with respect to the liquid electrolyte worked as a pillar, the localization of the dissolution/deposition site of ZnO is suppressed. It is further presumed that, since the additive includes at least one kind of Mg, Sr and La, and since the affinity of these elements and Zn(OH)₄²⁻ is high, the localization of the dissolution/deposition site of ZnO was suppressed. Incidentally, the poor solubility in the present disclosure is a concept including insolubility.

Also, Patent Literature 2 discloses in [0064] that “it is also advantageous to add to an alkaline earth hydroxides such as calcium hydroxide, Ca(OH)₂, into an active material in order to reduce the solubility of the zincates, in an amount of about 5 to 35 weight % relative to the ZnO.” The alkaline earth metal generally corresponds to the elements belonging to the second group in the periodic table, and is referred to the elements of the fourth period and after. Specifically, the alkaline earth metal refers to the four kinds of elements of Ca, Sr, Ba, and Ra. Meanwhile, in the Examples described later, Mg(OH)₂ was used as the additive. Although Mg corresponds to the element belonging to the second group in the periodic table, it is not usually classified as an alkaline earth metal. This is because the atomic radius of Mg (and Be) is small, it has a covalent character, and the chemical properties thereof differ greatly from the alkaline earth metal. For reference, in relation to the solubility with respect to pure water, the solubility of Ca(OH)₂ is 1700 mg/L, whereas the solubility of Mg(OH)₂ is 12 mg/L.

The anode active material layer in the present disclosure comprises a Zn based active material and an additive. The anode active material layer may further comprise a conductive material and a binder.

(1) Additive

The additive in the present disclosure includes at least one kind of Mg, Sr and La. Also, the additive has poor solubility with respect to the liquid electrolyte (alkaline solution). The present disclosure employs a solubility (25° C.) with respect to a potassium hydrate aqueous solution of concentration of 6 M as an index of the poor solubility. Specifically, an additive is determined as having the poor solubility with respect to the liquid electrolyte when the solubility is 120 mg/L or less. Incidentally, the solubility of 120 mg/L is synonymous as the amount of a solvent needed to dissolve 1.2 g of a solute is 10000 mL (10 L) or more. The solubility may be 100 mg/L or less, may be 50 mg/L or less, may be 25 mg/L or less, may be 10 mg/L or less, and may be 1 mg/L or less. The solubility may be specified by adding an additive to a potassium hydrate aqueous solution of concentration of 6 M, leaving the solution to stand for one night at 25° C., and measuring the amount of the additive deposited in the aqueous solution with an induction coupling plasma (ICP) emission spectrophotometer.

The additive may include at least Mg. In this case, the additive may include only Mg as a cation component, and may include Mg as a main component with other metal element. In the present disclosure, “including as a main component” means that the molar ratio thereof is the highest.

The additive may include at least Sr. In this case, the additive may include only Sr as a cation component, and may include Sr as a main component with other metal element. Also, the additive may include at least La. In this case, the additive may include only La as a cation component, and may include La as a main component with other metal element.

The additive is preferably a hydroxide, an oxide, a fluoride, a pyrophosphate, a titanate, or a phosphate. The hydroxide is a compound including a hydroxide ion (OH⁻) as a main component of anion components. The oxide is a compound including an oxygen ion (O²⁻) as a main component of anion components. The fluoride is a compound including a fluoride ion (F⁻) as a main component of anion components. The phosphate is a compound including a phosphate ion (PO₄³⁻) as a main component of anion components. The pyrophosphate is a compound including a pyrophosphate ion (P₂O₇⁴⁻) as a main component of anion components. The titanate is a compound including a titanate ion (TiO₃⁴⁻) as a main component of anion components.

Incidentally, the fluoride is low in the solubility in many cases. For reference, in relation to the solubility with respect to pure water, the solubility of MgF₂ is 87 mg/L, whereas the solubility of SrF₂ is 117 mg/L.

Specific examples of the additive may include Mg(OH)₂, Mg₂P₂O₇, Mg₂TiO₃, Mg₃(PO₄)₂, MgO, MgF₂, SrF₂, and LaF₃. The anode active material layer may include only one kind of the additive, and may include two kinds or more.

Examples of the shape of the additive may include a granular shape. The average particle size (D₅₀) of the additive is, for example, 1 μm or more and may be 300 μm or less. The average particle size (D₅₀) is a so-called median diameter, and may be calculated from a measurement with, for example, a laser diffraction particle size analyzer, and a scanning type electron microscope (SEM).

In the anode active material layer, the ratio of the additive with respect to the Zn based active material is usually 1 weight % or more, may be 5 weight % or more, and may be 10 weight % or more. When the ratio of the additive is too low, the cycle property may not be sufficiently improved. Meanwhile, the ratio of the additive with respect to the Zn based active material is usually 60 weight % or less. When the ratio of the additive is too high, the ratio of the Zn based active material is relatively decreased so that the volume energy density may be decreased. Also, the ratio of the additive with respect to the Zn based active material may be, for example, more than 35 weigh %, may be 37 weight % or more, and may be 40 weight % or more.

(2) Zn Based Active Material

The Zn based active material includes zinc (Zn) element. Examples of the Zn based active material may include a Zn simple substance, a Zn alloy, a Zn oxide, and a Zn hydroxide. The Zn alloy is preferably an alloy including Zn as a main component. The ratio of Zn in the Zn alloy is, for example, 50 atm % or more, may be 70 atm % or more, and may be 90 atm % or more. The Zn alloy may further include, for example, at least one kind of In, Al, Bi, Mg and Ca. Examples of the Zn oxide may include ZnO. Also, examples of the Zn hydroxide may include Zn(OH)₂. The anode active material layer may include only one kind of the Zn based active material, and may include two kinds or more.

Examples of the shape of the Zn based active material may include a granular shape. The average particle size (D₅₀) of the Zn based active material is, for example, 1 μm or more and may be 300 μm or less. The ratio of the Zn based active material in the anode active material layer is, for example, 50 weight % or more, and may be 70 weight % or more. Meanwhile, the ratio of the Zn based active material in the anode active material layer is, for example, less than 100 weight %.

(3) Anode Active Material Layer

The anode active material layer may further include at least one of a conductive material and a binder. By using the conductive material, the electron conductivity of the anode active material layer is improved. Examples of the conductive material may include a metal powder such as Ni powder; an oxide such as cobalt oxide; and a carbon material such as graphite and carbon nanotube. Further, examples of the binder may include a rubber based binder such as styrene butadiene rubber; a cellulose based binder such as carboxymethylcellulose (CMC); and a fluorine resin based binder such as polyvinylidene fluoride (PVDF). Also, the anode active material layer in the present disclosure is usually used for an alkaline storage battery.

B. Alkaline Storage Battery

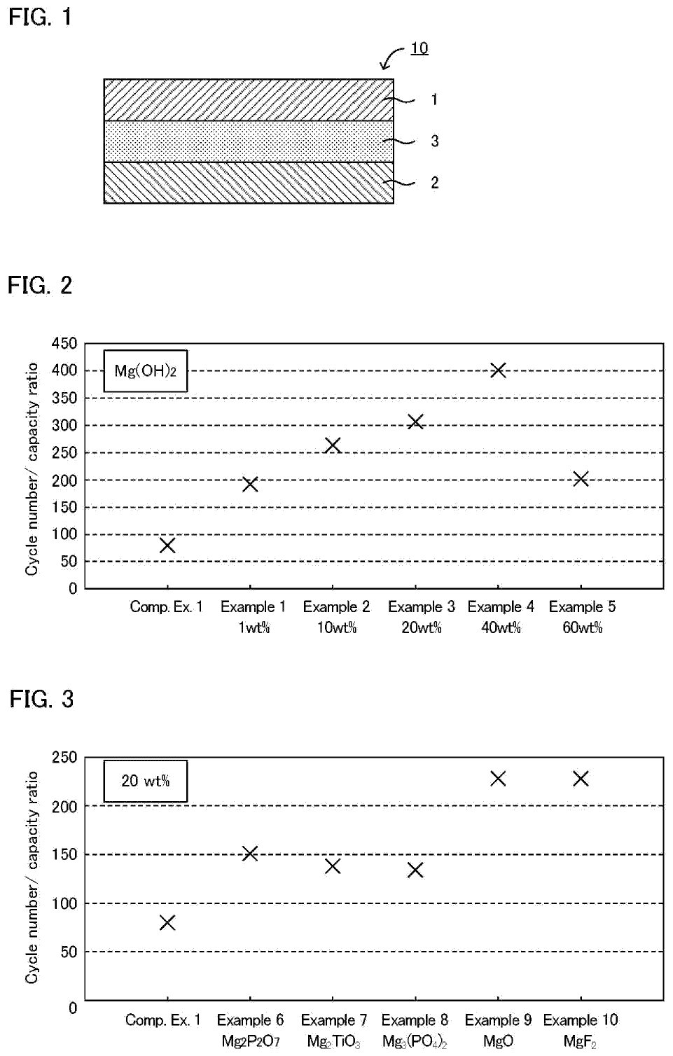

FIG. 1 is a schematic cross-sectional view exemplifying the alkaline storage battery in the present disclosure. Alkaline storage battery 10 shown in FIG. 1 includes cathode active material layer 1 including Ni(OH)₂ as a cathode active material; anode active material layer 2 described above; and electrolyte layer 3 including an liquid electrolyte (alkaline solution), formed between the cathode active material layer 1 and the anode active material layer 2. The alkaline storage battery 10 shown in FIG. 1 corresponds to a so-called nickel-zinc battery (Ni—Zn battery), in which following reactions occur:

Cathode:NiOOH+H₂O+e⁻↔Ni(OH)₂+OH⁻; and

Anode:Zn+2OH⁻↔ZnO+H₂O+2e⁻.

Also, as the cathode active material, oxygen (O₂) may be used instead of Ni(OH)₂. Oxygen is, for example, supplied from the atmospheric air during discharge and released to the atmospheric air during charge. Such an alkaline battery corresponds to an air-zinc battery (Air-Zn), in which following reactions occur:

Cathode:O₂+2H₂O+4e⁻↔4OH⁻; and

Anode:Zn+2OH⁻↔ZnO+H₂O+2e⁻.

According to the present disclosure, by using the anode active material layer described above, the alkaline storage battery may have excellent cycle property.

1. Anode Active Material Layer

The anode active material layer in the present disclosure may be in the same contents as those described in “A. Anode active material layer” above; thus, the description herein is omitted. In an alkaline storage battery, the additive included in the anode active material layer usually exists as a solid.

2. Cathode Active Material Layer

The cathode active material layer includes at least a cathode active material. The cathode active material layer may further include at least one of a conductive material and a binder. Examples of the cathode active material may include a metal simple substance, an alloy, and a hydroxide. In specific, the cathode active material preferably includes a Ni element, more preferably a nickel hydroxide. The conductive material and the binder are in the same contents as those described in “A. Anode active material layer” above. Also, when the cathode active material of the cathode active material layer is air, a catalyst that promotes electrode reaction is preferably included. Examples of the catalyst may include a noble metal such as Pt and a composite oxide such as a Perovskite type oxide.

3. Electrolyte Layer

The electrolyte layer is formed between the cathode active material layer and the anode active material layer, and includes an alkaline solution as a liquid electrolyte. Examples of the solute of the alkaline solution may include a metal hydroxide such as a potassium hydroxide (KOH) and a sodium hydroxide (NaOH). Examples of the solvent of the alkaline solution may include water. The ratio of water with respect to all the solvents of the liquid electrolyte is, for example, 50 mol % or more, may be 70 mol % or more, and may be 90 mol % or more. Also, the concentration of the solute in the alkaline solution is, for example, 3 mol/L or more, and may be 5 mol/L or more. Meanwhile, the concentration of the solute in the alkaline solution is, for example, 8 mol/L or less. Also, a separator may be placed between the cathode active material layer and the anode active material layer, and the separator may be impregnated with the alkaline solution. A known separator may be used as the separator.

4. Alkaline Storage Battery

The alkaline storage battery in the present disclosure includes at least the above described anode active material layer, cathode active material layer and electrolyte layer. The alkaline storage battery may include a cathode current collector for collecting electrons from the cathode active material layer. Examples of the material for the cathode current collector may include stainless steel, nickel, iron and titanium. Examples of the shape of the cathode current collector may include a foil shape, a mesh shape, and a porous shape. Also, the alkaline storage battery may include an anode current collector for collecting electrons from the anode active material layer. Examples of the material for the anode current collector may include copper, stainless steel, nickel, iron, titanium and carbon. Examples of the shape of the anode current collector may include a foil shape, a mesh shape, and a porous shape. As an outer package of the alkaline storage battery, known outer packages may be used.

The alkaline storage battery in the present disclosure is preferably a secondary battery. Also, the use of the alkaline storage battery is not particularly limited, and examples thereof may include a power supply of a vehicle such as a hybrid electric vehicle (HEV).

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Comparative Example 1

(Preparation of Liquid Electrolyte)

A potassium hydrate (KOH) aqueous solution of concentration of 6 M (mol/L) was prepared by mixing a potassium hydrate (KOH) aqueous solution of concentration of 4 M (mol/L), and potassium hydrate (KOH) aqueous solution of concentration of 8 M (mol/L). Then, zinc oxide (ZnO) was added to the obtained aqueous solution until a precipitate is formed. Then, the obtained mixture was left to stand for one night in a constant temperature bath at 25° C. Thereby, a liquid electrolyte including the potassium hydrate (KOH) of concentration of 6 M (mol/L) and ZnO of saturated concentration was obtained.

(Production of Separator)

A polypropylene separator (PP separator 20 μm×58 mm×70 mm) was prepared, and a hydrophilizing treatment was carried out thereto. Specifically, 1 g of a fluorine based surfactant was added and stirred into a mixture solution including 50 g of ethanol and 50 g of ultrapure water. The PP separator was immersed for 1 minute into the solution after stirring, and then, dried naturally. Thereby, a hydrophilizing treated PP separator was obtained. Then, the hydrophilizing treated PP separators were respectively placed on both surfaced of a non-woven fabric PP separator to obtain a separator.

(Production of Cathode)

A cathode active material (Nickel hydroxide, (Ni(OH)₂), a conductive material (cobalt oxide, CoO) a first binder (styrene butadiene rubber, SBR), and a second binder (carboxymethylcellurose, CMC) were weighed so as the weight ratio was Ni(OH)₂:CoO:SBR:CMC=87:10:2.5:0.5, and kneaded in a mortar. Then, ultrapure water was added, and the mixture was mixed using a rotating and revolving mixer (Thinky Mixer, from Thinky Corporation) under conditions of 2000 rpm for 1 minute to obtain an ink. A surface of a cathode current collector (Ni foil) was coated with the obtained ink by a doctor blade. After drying naturally, the resultant was dried for one night under decompression environment at 80° C. Thereby, a cathode including a cathode current collector and a cathode active material layer was obtained.

(Production of Anode)

A first anode active material (zinc oxide, ZnO), a second anode active material (zinc, Zn), a first binder (styrene butadiene rubber, SBR), and a second binder (carboxymethylcellurose, CMC) were weighed so as the weight ratio was ZnO:Zn:SBR:CMC=77:20:2.5:0.5, and kneaded in a mortar. Then, ultrapure water was added, and the mixture was mixed using a rotating and revolving mixer (Thinky Mixer, from Thinky Corporation) under conditions of 2000 rpm for 1 minute to obtain an ink. A surface of an anode current collector (Sn plated Cu foil) was coated with the obtained ink by a doctor blade. After drying naturally, the resultant was dried for one night under decompression environment at 80° C. Thereby, an anode including an anode current collector and an anode active material layer was obtained.

(Production of Evaluation Battery)

The obtained cathode, anode, separator, and liquid electrolyte were placed on a resin bipolar cell (SB8, from EC Frontier Co., Ltd.) to obtain an evaluation battery.

### Example 1

An evaluation battery was obtained in the same manner as in Comparative Example 1 except that, in the production of the anode, Mg(OH)₂ was used as the additive, and the weight ratio of the additive was changed so as to be 1 weight % with respect to the Zn based active material (ZnO+Zn) (specifically, the ratio of Zn in the anode active material layer was fixed to 10 weight %, and the weight ratio was adjusted by decreasing the ratio of ZnO).

### Examples 2 to 5

An evaluation battery was obtained in the same manner as in Example 1 except that the weight ratio of the additive was changed so as to be 10 weight %, 20 weight %, 40 weight % and 60 weight % respectively, with respect to the Zn based active material (ZnO+Zn).

[Evaluation]

Using the evaluation batteries obtained in Examples 1 to 5 and Comparative Example 1, a charge/discharge measurement was carried out to evaluate the cycle stability. For the charge/discharge measurement, an electrochemical measurement system (VMP3, from Bio-Logic Science Instruments) and a constant temperature bath (SU-642, from Espec Corp.) was used. Also, charge/discharge conditions were as follows.

Charge/discharge range: SOC 0% to 100% (the theoretical capacity of the cathode was regarded as 100%)

Charge/discharge current: 3.5 mA/cm²

Cut off voltage: charge 2V, discharge 1.3 V

Rest: 5 minutes

In the charge/discharge measurement, the initial discharge capacity was regarded as 100%, number of the cycles wherein the discharge capacity decreased to 70%, was counted. Also, the number of cycles was standardized by dividing thereof by the capacity ratio (anode capacity/cathode capacity). The results are shown in Table 1 and FIG. 2.

TABLE 1

| | Additive | | |
|---|---|---|---|
| | | Ratio (wt % vs Zn | Cycle number/ |
| | Type | based active material) | capacity ratio |
| Comp. Ex. 1 | — | — | 80 |
| Example 1 | Mg(OH)₂ | 1 | 192 |
| Example 2 | Mg(OH)₂ | 10 | 264 |
| Example 3 | Mg(OH)₂ | 20 | 307 |
| Example 4 | Mg(OH)₂ | 40 | 401 |
| Example 5 | Mg(OH)₂ | 60 | 202 |

As shown in Table 1 and FIG. 2, the cycle stability in Examples 1 to 5 was excellent, compared to Comparative Example 1.

### Examples 6 to 10

A battery was obtained in the same manner as in Example 3 except that Mg₂P₂O₇, Mg₂TiO₃, Mg₃(PO₄)₄, MgO, and MgF₂ were respectively used as the additive.

[Evaluation]

Using the evaluation batteries obtained in Examples 6 to 10, a charge/discharge measurement was carried out as described above to evaluate the cycle stability. The results are shown in Table 2 and FIG. 3.

TABLE 2

| | Additive | | |
|---|---|---|---|
| | | Ratio (wt % vs Zn | Cycle number/ |
| | Type | based active material) | capacity ratio |
| Comp. Ex. 1 | — | — | 80 |
| Example 6 | Mg₂P₂O₇ | 20 | 151 |
| Example 7 | Mg₂TiO₃ | 20 | 138 |
| Example 8 | Mg₃(PO₄)₂ | 20 | 134 |
| Example 9 | MgO | 20 | 228 |
| Example 10 | MgF₂ | 20 | 228 |

As shown in Table 2 and FIG. 3, the cycle stability in Examples 6 to 10 was excellent, compared to Comparative Example 1. Also, from the results in Examples 6 to 10 and Example 1, it was confirmed that excellent cycle stability was obtained with variety of additives including Mg.

### Examples 11 and 12

An evaluation battery was obtained in the same manner as in Example 3 except that SrF₂, and LaF₃ were respectively used as the additive.

### Comparative Examples 2 and 3

An evaluation battery was obtained in the same manner as in Example 3 except that NiF₂, and CaF₂ were respectively used as the additive.

[Evaluation]

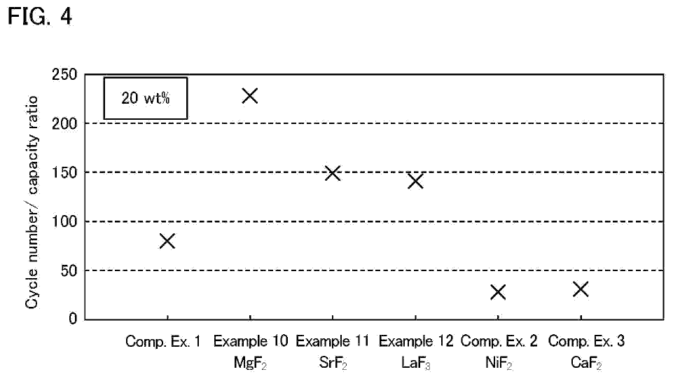

Using the evaluation batteries obtained in Examples 11 and 12 and Comparative Examples 2 and 3, a charge/discharge measurement was carried out as described above to evaluate the cycle stability. The results are shown in Table 3 and FIG. 4.

TABLE 3

| | Additive | | |
|---|---|---|---|
| | | Ratio (wt % vs Zn | Cycle number/ |
| | Type | based active material) | capacity ratio |
| Comp. Ex. 1 | — | — | 80 |
| Example 10 | MgF₂ | 20 | 228 |
| Example 11 | SrF₂ | 20 | 149 |
| Example 12 | LaF₃ | 20 | 141 |
| Comp. Ex. 2 | NiF₂ | 20 | 28 |
| Comp. Ex. 3 | CaF₂ | 20 | 31 |

As shown in Table 3 and FIG. 4, the cycle stability in Examples 11 and 12 was excellent, compared to Comparative Example 1. Also, from the results in Examples 11 and 12 and Example 10, excellent cycle stability was obtained also with SrF₂ and LaF₃, those are fluorides other than MgF₂. Meanwhile, excellent cycle stability was not obtained with NiF₂ and LaF₃, as in Comparative Examples 2 and 3.

### Reference Example

A Mg(OH)₂ was added to a potassium hydrate (KOH) aqueous solution of concentration of 6 M (mol/L), and was left to stand for one night in a constant temperature bath at 25° C. Then, the concentration of Mg(OH)₂ dissolved in the aqueous solution was measured with an induction coupling plasma (ICP) emission spectrophotometer, and the concentration was the detection limit (0.01 mg/L) or less. Thus, it was confirmed that Mg(OH)₂ was hardly soluble with respect to the KOH aqueous solution.

### REFERENCE SINGS LIST

1 cathode active material layer
2 anode active material layer
3 electrolyte layer
10 alkaline storage battery

What is claimed is:

1. An anode active material layer to be used in an alkaline storage battery,
the anode active material layer comprising a Zn based active material, and an additive; and
the additive includes at least one kind of Mg, Sr and La;
a solubility (25° C.) of the additive with respect to a potassium hydrate aqueous solution of concentration of 6 M is 120 mg/L or less; and
a ratio of the additive with respect to the Zn based active material is 1 weight % or more and 60 weight % or less.

2. The anode active material layer according to claim 1, wherein the additive is a hydroxide, an oxide, a fluoride, a phosphate, a pyrophosphate, or a titanate.

3. The anode active material layer according to claim 1, wherein the additive is a hydroxide including Mg.

4. The anode active material layer according to claim 1, wherein the additive is an oxide, a fluoride, a phosphate, a pyrophosphate, or a titanate including Mg.

5. The anode active material layer according to claim 1, wherein the additive is a fluoride including at least one kind of Sr and La.

6. The anode active material layer according to claim 1, wherein the ratio of the additive with respect to the Zn based active material is more than 35 weight % and 60 weight % or less.

7. The anode active material layer according to claim 1, wherein, as the Zn based active material, the anode active material layer includes at least one kind of a Zn simple substance, a Zn alloy, a Zn oxide, and a Zn hydroxide.

8. An alkaline storage battery comprising a cathode active material layer, an anode active material layer, and an electrolyte layer placed between the cathode active material layer and the anode active material layer, and
the anode active material layer is the anode active material layer according to claim 1.
